(19) United States
(12) Patent Application Publication
(10) Pub. No.: US 2026/0057292 A1
(43) Pub. Date: Feb. 26, 2026

(54) METHOD AND SYSTEM FOR DETERMINING RECOURSE PATHS TO ACHIEVE A POSITIVE DECISION

(71) Applicant: JPMorgan Chase Bank, N.A., New York, NY (US)

(72) Inventors: Shubham SHARMA, Manhattan, NY (US); Leonidas TSEPENEKAS, College Park, MD (US); Margarita BOYARSKAYA, New York, NY (US); Freddy LECUE, Mamaroneck, NY (US)

(73) Assignee: JPMorgan Chase Bank, N.A., New York, NY (US)

(21) Appl. No.: 18/883,739

(22) Filed: Sep. 12, 2024

(30) Foreign Application Priority Data
Aug. 22, 2024 (GR) 20240100586

(51) Int. Cl. G06N 20/00

(52) U.S. Cl. CPC G06N 20/00

(57) ABSTRACT

A method and a system for determining a recourse path with respect to a decision that is associated with a positive outcome and a negative outcome are provided. The method includes: receiving a dataset including a data point representing an entity; determining, via a trained model, which data points from the dataset reach a positive outcome and which data points reach a negative outcome based on a distance threshold; determining transition labels from historical data; calculating an optimal distance function and an optimal threshold value for the dataset based on the transition labels; generating an augmentation algorithm based on the optimal distance function and the optimal threshold value; and generating a first recourse path for the first entity to reach the positive outcome by applying the augmentation algorithm to insert a second data point into the at least one dataset.

### CROSS-REFERENCE TO RELATED APPLICATIONS

This application claims priority benefit from Greek application No. 20240100586, filed on Aug. 22, 2024 in the Greek Patent Office, which is hereby incorporated by reference in its entirety.

### BACKGROUND

### 1. Field of the Disclosure

This technology generally relates to methods and systems for determining a recourse path with respect to a decision that is associated with a positive outcome and a negative outcome, and more particularly to methods and systems for augmenting a machine learning model generated recourse path with feasible transitions to ensure a positive outcome.

### 2. Background Information

Artificial intelligence (AI) and machine learning (ML) models are increasingly being used for algorithmic decision-making in high stakes applications. Hence, when individuals are adversely affected by these decisions, the provision of transparent explanations for the negative decisions becomes paramount. For example, consider the scenario where credit line applications of bank customers are denied. The imperative for transparency and explainability is further underscored by regulatory mandates such as the Equal Credit Opportunity Act (ECOA), the Fair Credit Reporting Act (FCRA), the ‘Right to Explanation’ enshrined in the European Union General Data Protection Regulation (EU-GDPR), and the U.S. AI Bill of Rights.

These explanations often take the form of sequential steps aimed at achieving desired or favorable outcomes for affected users. Such recommended steps represent algorithmic recourse and provide users with a pathway to address adverse decisions by gradually changing their profile to one that most likely receives the positive decision. Single-step recourses frequently rely on counterfactual explanations (CFEs), which propose changes to the input data that would lead to a different decision outcome. However, recent research has highlighted the limitations of single-step recourses, advocating instead for multi-step recourse paths towards favorable outcomes. It is imperative that such recourse paths remain realistic, meaning they should be both feasible and actionable, in order to effectively assist end-users. Furthermore, algorithms designed to provide realistic recourse paths should be able to provide recourse for every individual (i.e., realism constraints should not come at the cost of no recourse for some individuals).

Accordingly, there is a need for augmenting a machine learning model generated recourse path with feasible transitions to ensure a positive outcome.

### SUMMARY

The present disclosure, through one or more of its various aspects, embodiments, and/or specific features or sub-components, provides, inter alia, various systems, servers, devices, methods, media, programs, and platforms for augmenting a machine learning model generated recourse path with feasible transitions to ensure a positive outcome. According to an aspect of the present disclosure, a method for determining a recourse path with respect to a decision that is associated with a positive outcome and a negative outcome is provided. The method may be implemented by at least one processor. The method may include: receiving, by the at least one processor, at least one dataset including a first data point representing a first entity; determining, by the at least one processor via a trained model, which data points from the at least one dataset reach a positive outcome and which data points from the at least one dataset reach a negative outcome based on a predetermined distance threshold; determining, by the at least one processor, transition labels from historical data; calculating, by the at least one processor, an optimal distance function and an optimal threshold value for the at least one dataset based on the transition labels; generating, by the at least one processor, an augmentation algorithm based on the optimal distance function and the optimal threshold value; and when the first data point is determined to reach the negative outcome, generating, by the at least one processor, a first recourse path for the first entity to reach the positive outcome by applying the augmentation algorithm to insert a second data point into the at least one dataset. The second data point may be usable to create a transition that enables the first recourse path to extend from the first data point toward the positive outcome.

The method may further include formatting, by the at least one processor, raw data from the at least one dataset into a predetermined format by applying a data distribution sampling strategy. The augmentation algorithm may be further based on the formatted raw data.

The trained model may be trained for predictive recourse path modeling. The first recourse path may include a first series of data points from the at least one dataset that extend from a negative outcome side of a predetermined decision boundary to a positive outcome side of the predetermined decision boundary. A respective distance between each data point from the first series of data points and an adjacent data point from the first series of data points may be less than the predetermined threshold distance.

The transition labels may be based on a predetermined feasible transition strategy usable for determining whether moving between a first historical data point to a second historical data point is feasible.

The method may further include validating, by the at least one processor, the first recourse path by determining that each distance between each point within the first recourse path is less than or equal to the predetermined distance threshold.

The trained model may include at least one from among a deep learning model, a neural network model, a machine learning model, and a logistic regression model.

Each consecutive data point along the first recourse path may progress closer to the positive outcome.

The at least one dataset may relate to at least one from among healthcare data and financial data. The first recourse path may include actionable steps for the first entity to reach the positive outcome.

The at least one dataset may relate to financial data. The decision may relate to acceptance to at least one from among a service, a credit line, and an opportunity.

According to another aspect of the present disclosure, a computing apparatus for determining a recourse path with respect to a decision that is associated with a positive outcome and a negative outcome is provided. The computing apparatus includes a processor; a memory; a display; and a communication interface coupled to each of the processor, the memory, and the display. The processor may be configured to: receive at least one dataset including a first data point representing a first entity; determine, via a trained model, which data points from the at least one dataset reach a positive outcome and which data points from the at least one dataset reach a negative outcome based on a predetermined distance threshold; determine transition labels from historical data; calculate an optimal distance function and an optimal threshold value for the at least one dataset based on the transition labels; generate an augmentation algorithm based on the optimal distance function and the optimal threshold value; and when the first data point is determined to reach the negative outcome, generate a first recourse path for the first entity to reach the positive outcome by applying the augmentation algorithm to insert a second data point into the at least one dataset. The second data point may be usable to create a transition that enables the first recourse path to extend from the first data point toward the positive outcome.

The processor may be further configured to format raw data from the at least one dataset into a predetermined format by applying a data distribution sampling strategy. The augmentation algorithm may be further based on the formatted raw data.

The trained model may be trained for predictive recourse path modeling. The first recourse path may include a first series of data points from the at least one dataset that extend from a negative outcome side of a predetermined decision boundary to a positive outcome side of the predetermined decision boundary. A respective distance between each data point from the first series of data points and an adjacent data point from the first series of data points may be less than the predetermined threshold distance.

The transition labels may be based on a predetermined feasible transition strategy usable for determining whether moving between a first historical data point to a second historical data point is feasible.

The processor may be further configured to validate the first recourse path by determining that each distance between each point within the first recourse path is less than or equal to the predetermined distance threshold.

The trained model may include at least one from among a deep learning model, a neural network model, a machine learning model, and a logistic regression model.

Each consecutive data point along the first recourse path may progress closer to the positive outcome.

The at least one dataset may relate to at least one from among healthcare data and financial data. The first recourse path may include actionable steps for the first entity to reach the positive outcome.

The at least one dataset may relate to financial data. The decision may relate to acceptance to at least one from among a service, a credit line, and an opportunity.

According to yet another aspect of the present disclosure, a non-transitory computer readable storage medium storing instructions for determining a recourse path with respect to a decision that is associated with a positive outcome and a negative outcome is provided. The storage medium includes executable code which, when executed by a processor, causes the processor to: receive at least one dataset including a first data point representing a first entity; determine, via a trained model, which data points from the at least one dataset reach a positive outcome and which data points from the at least one dataset reach a negative outcome based on a predetermined distance threshold; determine transition labels from historical data; calculate an optimal distance function and an optimal threshold value for the at least one dataset based on the transition labels; generate an augmentation algorithm based on the optimal distance function and the optimal threshold value; and when the first data point is determined to reach the negative outcome, generate a first recourse path for the first entity to reach the positive outcome by applying the augmentation algorithm to insert a second data point into the at least one dataset. The second data point may be usable to create a transition that enables the first recourse path to extend from the first data point toward the positive outcome.

The trained model may be trained for predictive recourse path modeling. The first recourse path may include a first series of data points from the at least one dataset that extend from a negative outcome side of a predetermined decision boundary to a positive outcome side of the predetermined decision boundary. A respective distance between each data point from the first series of data points and an adjacent data point from the first series of data points may be less than the predetermined threshold distance.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for augmenting a machine learning model generated recourse path with feasible transitions to ensure a positive outcome, according to an embodiment.

FIG. 2 illustrates a diagram of a network environment for augmenting a machine learning model generated recourse path with feasible transitions to ensure a positive outcome, according to an embodiment.

FIG. 3 illustrates a system diagram of a system for augmenting a machine learning model generated recourse path with feasible transitions to ensure a positive outcome, according to an embodiment.

FIG. 4 illustrates a process diagram of a process for augmenting a machine learning model generated recourse path with feasible transitions to ensure a positive outcome, according to an embodiment.

FIG. 5 illustrates an augmentation algorithm for augmenting a machine learning model generated recourse path with feasible transitions to ensure a positive outcome, according to an embodiment.

FIG. 6 illustrates an empirical risk minimizer (ERM) algorithm for augmenting a machine learning model generated recourse path with feasible transitions to ensure a positive outcome, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

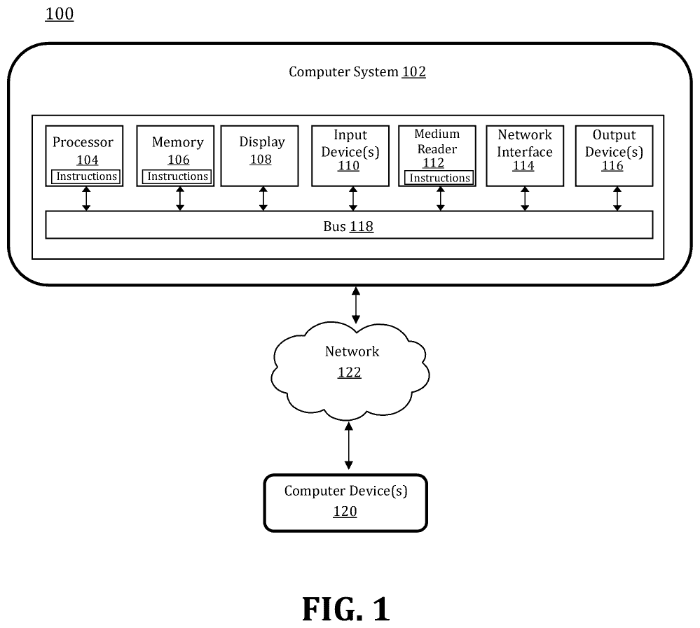

FIG. 1 is a system 100 for augmenting a machine learning model generated recourse path with feasible transitions to ensure a positive outcome in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the rrecourse path augmentation module implemented by the system 100 may allow for augmenting a machine learning model generated recourse path with feasible transitions to ensure a positive outcome. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

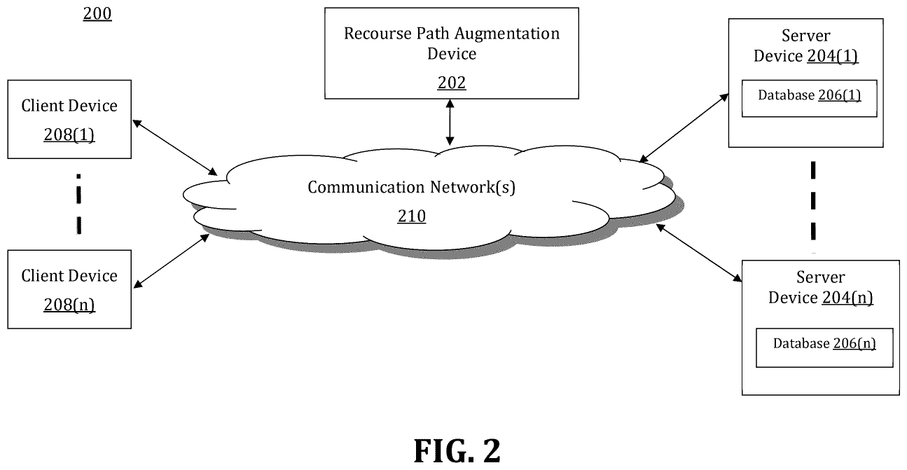

Referring to FIG. 2, a schematic of a network environment 200 for augmenting a machine learning model generated recourse path with feasible transitions to ensure a positive outcome of the instant disclosure is illustrated.

In some embodiments, the above-described problems associated with conventional tools may be overcome by implementing a recourse path augmentation device 202 as illustrated in FIG. 2 that may be configured for augmenting a machine learning model generated recourse path with feasible transitions to ensure a positive outcome, but the disclosure is not limited thereto.

The recourse path augmentation device 202 may include one or more computer systems 102, as described with respect to FIG. 1, which in aggregate provide the necessary functions.

The recourse path augmentation device 202 may store one or more applications that can include executable instructions that, when executed by the recourse path augmentation device 202, cause the recourse path augmentation device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the recourse path augmentation device 202 itself, may be located in virtual server(s) running in a cloud-based computing environment rather than being tied to one or more specific physical network computing devices. Also, the application(s) may be running in one or more virtual machines (VMs) executing on the recourse path augmentation device 202. Additionally, in one or more embodiments of this technology, virtual machine(s) running on the recourse path augmentation device 202 may be managed or supervised by a hypervisor.

In the network environment 200 of FIG. 2, the recourse path augmentation device 202 may be coupled to a plurality of server devices 204(1)-204(n) that hosts a plurality of databases 206(1)-206(n), and also to a plurality of client devices 208(1)-208(n) via communication network(s) 210. A communication interface of the recourse path augmentation device 202, such as the network interface 114 of the computer system 102 of FIG. 1, operatively couples and communicates between the recourse path augmentation device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the recourse path augmentation device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The recourse path augmentation device 202 may be a standalone device or integrated with one or more other devices or apparatuses, such as one or more of the server devices 204(1)-204(n), for example. In one example, the recourse path augmentation device 202 may be hosted by one of the server devices 204(1)-204(n), and other arrangements are also possible. Moreover, one or more of the devices of the recourse path augmentation device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the recourse path augmentation device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the recourse path augmentation device 202 that may efficiently provide a platform for augmenting a machine learning model generated recourse path with feasible transitions to ensure a positive outcome, but the disclosure is not limited thereto.

The client devices 208(1)-208(n) may run interface applications, such as standard web browsers or standalone client applications, which may provide an interface to communicate with the recourse path augmentation device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the recourse path augmentation device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the recourse path augmentation device 202, the server devices 204(1)-204(n), or the client devices 208(1)-208(n), for example, may be configured to operate as virtual instances on the same physical machine. For example, one or more of the recourse path augmentation devices 202, the server devices 204(1)-204(n), or the client devices 208(1)-208(n) may operate on the same physical device rather than as separate devices communicating through communication network(s) 210. Additionally, there may be more or fewer recourse path augmentation devices 202, server devices 204(1)-204(n), or client devices 208(1)-208(n) than illustrated in FIG. 2. In some embodiments, the recourse path augmentation device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

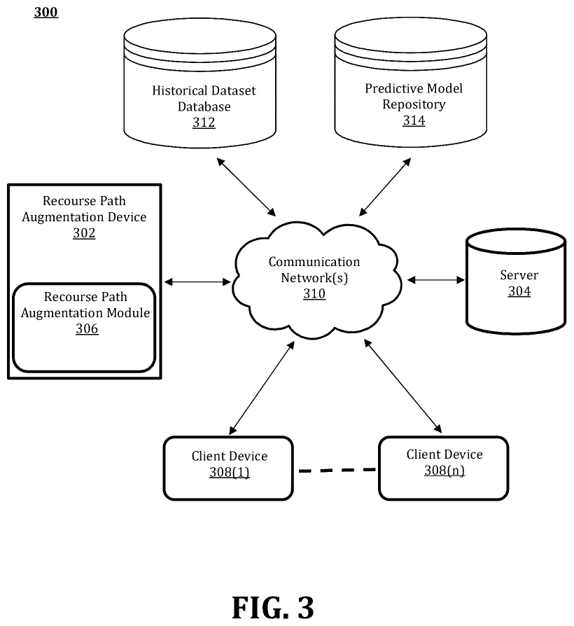

FIG. 3 illustrates a system diagram for augmenting a machine learning model generated recourse path with feasible transitions to ensure a positive outcome in accordance with an embodiment.

As illustrated in FIG. 3, the system 300 may include a recourse path augmentation device 302 within which a recourse path augmentation module 306 is embedded, a server 304, a historical dataset database 312, a predictive model repository 314, a plurality of client devices 308(1) . . . 308(n), and a communication network 310.

In some embodiments, the recourse path augmentation device 302 including the recourse path augmentation module 306 may be connected to the server 304, and the database(s) 312 via the communication network 310. The recourse path augmentation device 302 may also be connected to the plurality of client devices 308(1) . . . 308(n) via the communication network 310, but the disclosure is not limited thereto. The historical dataset database 312 and the predictive model repository 314 may include one or more repositories or databases.

In an embodiment, the recourse path augmentation device 302 is described and shown in FIG. 3 as including the recourse path augmentation module 306, although it may include other rules, policies, modules, databases, or applications, for example. In some embodiments, the historical dataset database 312 and the predictive model repository 314 may be configured to store ready to use modules written for each Application Programming Interface (API) for all environments. Although only one database and one repository are illustrated in FIG. 3, the disclosure is not limited thereto. Any number of desired databases and/or repositories may be utilized for use in the disclosed invention herein. The historical dataset database 312 and the predictive model repository 314 may be a mainframe database, a log database that may produce programming for searching, monitoring, and analyzing machine-generated data via a web interface, but the disclosure is not limited thereto. In addition, the historical dataset database 312 and the predictive model repository 314 may store a plurality of data sets and predictive models for generating recourse paths.

In some embodiments, the recourse path augmentation module 306 may be configured to receive real-time feed of data from the plurality of client devices 308(1) . . . 308(n) and secondary sources via the communication network 310.

The recourse path augmentation module 306 may be configured to: receive at least one dataset including a first data point representing a first entity; initiate, via a trained model, a first recourse path for the first entity to reach a positive outcome based on the at least one dataset and a predetermined distance threshold, wherein the first entity reaches the negative outcome in an absence of the first recourse path; determine transition labels from historical data; calculate an optimal distance function and an optimal threshold value for the at least one dataset based on the transition labels; generate an augmentation algorithm based on the optimal distance function and the optimal threshold value; and extend the first recourse path for the first entity to reach the positive outcome by applying the augmentation algorithm to the first recourse path to insert a second data point into the at least one dataset that is usable to create a transition for the extended first recourse path toward the positive outcome.

The plurality of client devices 308(1) . . . 308(n) are illustrated as being in communication with the recourse path augmentation device 302. In this regard, the plurality of client devices 308(1) . . . 308(n) may be “clients” (e.g., customers) of the recourse path augmentation device 302 and are described herein as such. Nevertheless, it is to be known and understood that the plurality of client devices 308(1) . . . 308(n) need not necessarily be “clients” of the recourse path augmentation device 302, or any entity described in association therewith herein. Any additional or alternative relationship may exist between either or both plurality of client devices 308(1) . . . 308(n) and the recourse path augmentation device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the recourse path augmentation device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The recourse path augmentation device 302 may be the same or similar to the recourse path augmentation device 202 as described with respect to FIG. 2, including any features or combination of features described with respect thereto.

Upon being started, the recourse path augmentation device 302 executes a process for augmenting a machine learning model generated recourse path with feasible transitions to ensure a positive outcome.

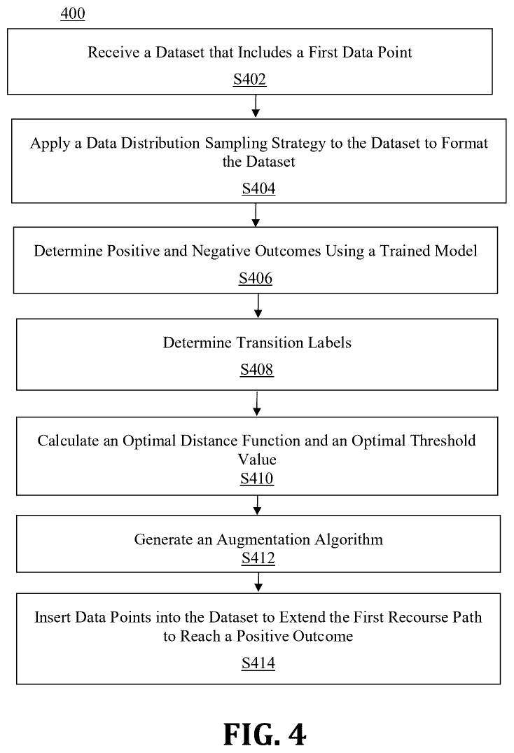

Referring to FIG. 4, a process 400 for augmenting a machine learning model generated recourse path with feasible transitions to ensure a positive outcome is illustrated, according to an embodiment.

In process 400 of FIG. 4, at step S402, the recourse path augmentation device 302 may receive a dataset that includes a first data point. The first data point may represent at least one entity. The at least one entity may include an individual, a family, an organization, and/or any other group or collection of people. The dataset may include at least one series or set of metrics used for making a decision and/or determining an outcome. The first data point may be on a negative outcome side of a decision matrix. In an embodiment, the dataset may relate to at least one from among healthcare data and financial data. In an embodiment, the first data point may represent an individual bank customer that is denied a credit line or loan.

At step S404, the recourse path augmentation device 302 may apply a data distribution sampling strategy to the dataset to format the dataset. In some embodiments, the raw data from the dataset is formatted into a predetermined format. In an embodiment, the dataset may contain categorical features that are changed into a particular format to be used by the augmentation algorithm.

At step S406, the recourse path augmentation device 302 may use a trained model to determine whether each data point from the dataset reaches a positive outcome or a negative outcome. The trained model may determine whether there are a series of data points within the dataset set to create a path for a data point to go from a negative outcome to a positive outcome based on a predetermined distance threshold that determines the maximum allowed distance between data points. In an embodiment, the trained model includes at least one from among a deep learning model, a neural network model, a machine learning model, and a logistic regression model. In some embodiments, the trained model may not be able to determine a path for a data point from the given the dataset to reach the positive outcome.

At step S408, the recourse path augmentation device 302 may determine transition labels from historical data. In an embodiment, the transition labels may be based on a predetermined feasible transition strategy that may determine whether moving between a first historical data point to a second historical data point is feasible. In some embodiments, if it is feasible to go from one data point to another, the transition between the two points will have a transition label equal to one (1.0). If it is not feasible to go from one data point to another, the transition between the two points will have a transition label equal to zero (0.0).

At step S410, the recourse path augmentation device 302 may calculate an optimal distance function and an optimal threshold value for the dataset. In an embodiment, the optimal distance function and the optimal threshold value are based on the determined transition labels and the historical data. In some embodiments, the optimal distance function and the optimal threshold value may quantify whether it is correct and feasible to go from one data point to another. In an embodiment, the optimal distance function and the optimal threshold value may be used to characterize a transition as feasible if the distance between two points is below the threshold value.

At step S412, the recourse path augmentation device 302 may generate an augmentation algorithm. In an embodiment, the augmentation algorithm may be based on at least one from among the determined outcomes generated by the trained model, the feasible transition labels, the distance function, the optimal threshold value, and the formatted categorical features from the data distribution sampling strategy. In some embodiments, the augmentation algorithm may generate at least one additional data point that is added to the dataset to create a transition that enables a path to be created that moves the first data point from a negative outcome to a positive outcome.

Then, at step S414, the recourse path augmentation device 302 may insert at least one data point into the dataset to generate a first recourse path so that a data point in the negative outcome reaches a positive outcome. In an embodiment, the inserted data point may be generated by the augmentation algorithm. In some embodiments, the augmentation algorithm may generate at least one additional data point that is added to the dataset to create a transition that enables a path to be created that moves the first data point from a negative outcome to a positive outcome. In an embodiment, the recourse path augmentation device 302 may generate a first recourse path by inserting at least one data point into the dataset to create a first series of data points from the at least one dataset that extend from a negative outcome side of a predetermined decision boundary to a positive outcome side of the predetermined decision boundary. The respective distance between each adjacent data point from the first series of data points may be equal to or less than the predetermined threshold distance. In an embodiment, the first recourse path may be validated by determining that each distance between each point within the first recourse path is less than or equal to the predetermined distance threshold. In some embodiments, each consecutive data point along the first recourse path may progress closer to the positive outcome. In an embodiment, the first recourse path may include actionable steps for the first entity to reach the positive outcome. In some embodiments, the dataset may relate to financial data and the decision may be an acceptance to at least one from among a service, a credit line, and an opportunity. In an embodiment, the first data point may represent an individual bank customer that is denied a credit line or loan. The recourse path may be a series of actionable steps or actions that lead to the individual being accepted for the credit line or loan. Each actionable step may be determined to be feasible for that particular individual given their situation and/or metrics.

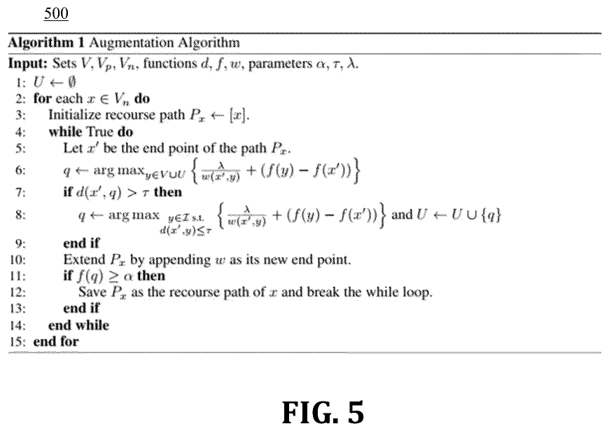

FIG. 5 illustrates an augmentation algorithm 500 for augmenting a machine learning model generated recourse path with feasible transitions to ensure a positive outcome, according to an embodiment. Specifically, FIG. 5 illustrates an augmentation algorithm 500 assuming d and t are given. In an embodiment, the augmentation algorithm 500 may give theoretical results for determining feasible transition relationships.

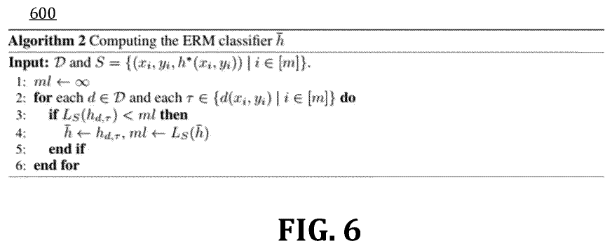

FIG. 6 illustrates an ERM algorithm 600 for augmenting a machine learning model generated recourse path with feasible transitions to ensure a positive outcome, according to an embodiment.

In an embodiment, the augmentation algorithm 500 may sequentially consider each point of Vₙ. For each x∈Vₙ the augmentation algorithm 500 may be used to construct a path to some positive point by iteratively expanding the end of the path. Initially, the path is just x. If the already constructed path is from x to x′ (x′ being the end point) then the augmentation algorithm 500 may be used to expand the path. For example, the recourse path augmentation device 302 may determine if there is a point in the current set of available points V∪U that can serve as a feasible and easy transition from x′, while encouraging this point to be closer to the boundary. Using this data, the recourse path augmentation device 302 may then solve for the optimization problem:

$$q = {arg max}_{y ∈ V ⋃ U} \{ \frac{λ}{w ( {x}^{′} , y )} + ( f ( y ) - f ( {x}^{′} ) ) \} \qquad ( 1 )$$

For the optimization problem (1), if d(x′, q)≤τ the recourse path augmentation device 302 may expand the path by adding q as the new end point. If this is not the case then the recourse path augmentation device 302 may solve the optimization problem (2) shown below, which tries to find a feasible transition to a new point q∉V∪U, and then the recourse path augmentation device 302 may augment U with it.

$$q = {arg max}_{\begin{matrix}y ∈ ℐ s . t . \\ d ( {x}^{′} , y ) \leq τ\end{matrix}} \{ \frac{λ}{w ( {x}^{′} , y )} + ( f ( y ) - f ( {x}^{′} ) ) \} \qquad ( 2 )$$

The first term, i.e., λ/w(x′, y), may guide the recourse path augmentation device 302 towards choosing transitions that are easy (have small weight w(x′, y)). In addition, λ>0 may be a hyperparameter that controls how important this term should be. The second term, i.e., f(y)−f(x′), may force the recourse path augmentation device 302 to move closer to the decision boundary of the classifier f, by maximizing the difference between f(y) and f(x′); the higher the f value of a point is the closer it is to receiving the positive outcome.

Including f(y) f(x′) in the maximization problem may help the algorithm converge and not revisit points that are already placed in the path. In an embodiment, the points of the path may consecutively move closer to the decision boundary; the f values may consecutively increase along the path, until the recourse path augmentation device 302 hits the classification threshold a. This may be the case in the absence of the first term. However, the presence of the first term may lead some iterations of the algorithm to prioritize small weights in the chosen transitions. By carefully tuning 2, the recourse path augmentation device 302 may ensure that the algorithm will always converge, even if there are iterations where the f-value of consecutive points decreases. Thus, recourse may be achievable for everyone.

In an embodiment, h*: [symbol] ² [symbol] {0, 1} may be the ground truth function that determines feasibility of transitions, i.e., for any x,y∈ [symbol] we have h*(x, y)=1 if x [symbol] y is feasible, 0 otherwise. In some embodiments, the recourse path augmentation device 302 may let:

$$= \{ {h}_{d , τ} = {\{ ( x , y ) ∈ {ℐ}^{2} \vert d ( x , y ) \leq τ \}}_{} \vert d ∈ and τ ∈ {ℝ}_{\geq 0} \} \qquad ( 3 )$$

where [symbol] may be a set of “distance” functions from [symbol] ² to [symbol] ≥0 Given [symbol] as the set of “distance” functions, [symbol] may be a hypothesis class, whose individual hypotheses are parameterized by d (the specific distance function used) and τ (a threshold). Then, each such hypothesis h_{d,τ} may return a one (1.0) for supposedly feasible transitions and a zero (0.0) otherwise, and is of the form:

$${h}_{d , τ} ( x , y ) = \{ \begin{matrix}1 & if d ( x , y ) \leq τ \\ 0 & otherwise\end{matrix} \qquad ( 4 )$$

In an embodiment, for any h∈ [symbol] and (x, y)∈ [symbol] ²; [symbol] (h, x, y) may be the 0−1 loss function, i.e.,

$$ℓ ( h , x , y ) = \{ \begin{matrix}1 & if h ( x , y ) \neq h * ( x , y ) \\ 0 & otherwise\end{matrix} \qquad ( 5 )$$

Additionally, L(h) may be the expected loss of h, where the expectation is over randomly drawing two individuals x, y from [symbol] according to the data producing distribution; L(h) may be viewed as the real loss of h. In addition, for a training set S that contains m labeled i.i.d. sampled pairs (xᵢ, yᵢ, h*(xᵢ, yᵢ)), the empirical loss of the classifier h may be defined as

$${L}_{S} ( h ) = {\sum }_{i = 1}^{m} ℓ ( h , {x}_{i} , \text{?} ) .$$

$$\text{?} \text{indicates text missing or illegible when filed}$$

In some embodiments, the goal may be to choose d∈ [symbol] and τ such that L(h_{d,τ}) is as small as possible.

Theorem 1. Let [symbol] be a hypothesis class, and let ϵ, δ∈(0, 1) be any desired accuracy and confidence parameters, respectively. Let VC be the VC-dimension of [symbol] . Let S be a training set with at least

$$O ( \frac{VC + log \text{?}}{\text{?}} \underline{)}$$

$$\text{?} \text{indicates text missing or illegible when filed}$$

training examples and h̅=arg [symbol] L_{S}(h). Then, with probability at least 1−δ, L(h̅)≤ [symbol] L(h)+ [symbol] . In an embodiment, the above theorem says that the empirical risk minimizer (ERM), i.e., h̅=arg [symbol] L_{S}(h) ϵ-approximates the best hypothesis of [symbol] with high probability, provided that the training set is large enough. For this theorem to be applied, VC needs to be bounded. The recourse path augmentation device 302 may prove that for the hypothesis class as defined in equation (3) above, VC is bounded as long as | [symbol] | is bounded. Specifically, VC depends on | [symbol] | in an inverse exponential way, which may make the required sample complexity highly practical in | [symbol] |.

Theorem 2. Let VC be the VC-dimension of the hypothesis defined in equation (3). If | [symbol] | is bounded, let N be the largest integer such that N!≤| [symbol] |. Then, VC≤N Thus, the smaller | [symbol] | is, the smaller the upper bound N for the VC-dimension. In addition, N may be the inverse factorial of | [symbol] |, and hence it is exponentially smaller than it. For example, when | [symbol] |=10¹⁰⁰⁰, N is just around 450. the ERM classifier h̅ may be computed efficiently, which may be easy to do when D is finite. For example, d∈ [symbol] is enumerated, and for a given d, the thresholds τ∈{d(xᵢ, yᵢ)|i∈[m]}, which are defined based on all the pairs in the training set S, are tried. For each combination of d and τ, the empirical error L_{S}(h_{d,τ}) is computed, and at the end, the combination with the smallest LS(.) is kept.

Theorem 3. The classifier h̅ computed by the ERM algorithm 600 is an ERM, i.e., h̅=arg [symbol] L_{S}(h) Combining theorems 1, 2, and 3, may prove theorem 4.

Theorem 4. Let [symbol] be the hypothesis class defined in equation (3), and let ϵ, δ∈(0, 1) be any desired accuracy and confidence parameters, respectively. Let N be as defined in Theorem 2. Let S be a training set with at least

$$O ( \frac{VC + log \text{?}}{\text{?}} \underline{)}$$

$$\text{?} \text{indicates text missing or illegible when filed}$$

training examples. Then h̅=arg [symbol] L_{S}(h) may be efficiently computed, and with probability at least 1−δ, L(h̅)≤ [symbol] L(h)+ϵ.

Accordingly, with this technology, an optimized process for augmenting a machine learning model generated recourse path with feasible transitions to ensure a positive outcome is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for determining a recourse path with respect to a decision that is associated with a positive outcome and a negative outcome, the method being implemented by at least one processor, the method comprising:
receiving, by the at least one processor, at least one dataset including a first data point representing a first entity;
determining, by the at least one processor via a trained model, which data points from the at least one dataset reach a positive outcome and which data points from the at least one dataset reach a negative outcome based on a predetermined distance threshold;
determining, by the at least one processor, transition labels from historical data;
calculating, by the at least one processor, an optimal distance function and an optimal threshold value for the at least one dataset based on the transition labels;
generating, by the at least one processor, an augmentation algorithm based on the optimal distance function and the optimal threshold value; and
when the first data point is determined to reach the negative outcome, generating, by the at least one processor, a first recourse path for the first entity to reach the positive outcome by applying the augmentation algorithm to insert a second data point into the at least one dataset,
wherein the second data point is usable to create a transition that enables the first recourse path to extend from the first data point toward the positive outcome.

2. The method of claim 1, further comprising
formatting, by the at least one processor, raw data from the at least one dataset into a predetermined format by applying a data distribution sampling strategy,
wherein the augmentation algorithm is further based on the formatted raw data.

3. The method of claim 1, wherein the trained model is trained for predictive recourse path modeling,
wherein the first recourse path includes a first series of data points from the at least one dataset that extend from a negative outcome side of a predetermined decision boundary to a positive outcome side of the predetermined decision boundary, and
wherein a respective distance between each data point from the first series of data points and an adjacent data point from the first series of data points is less than the predetermined threshold distance.

4. The method of claim 1, wherein the transition labels are based on a predetermined feasible transition strategy usable for determining whether moving between a first historical data point to a second historical data point is feasible.

5. The method of claim 1, further comprising:
validating, by the at least one processor, the first recourse path by determining that each distance between each point within the first recourse path is less than or equal to the predetermined distance threshold.

6. The method of claim 1, wherein the trained model includes at least one from among a deep learning model, a neural network model, a machine learning model, and a logistic regression model.

7. The method of claim 1, wherein each consecutive data point along the first recourse path progresses closer to the positive outcome.

8. The method of claim 1, wherein the at least one dataset relates to at least one from among healthcare data and financial data, and
wherein the first recourse path includes actionable steps for the first entity to reach the positive outcome.

9. The method of claim 8, wherein the at least one dataset relates to financial data, and
wherein the decision relates to acceptance to at least one from among a service, a credit line, and an opportunity.

10. A computing apparatus for determining a recourse path with respect to a decision that is associated with a positive outcome and a negative outcome, the computing apparatus comprising:
at least one processor;
a memory;
a display; and
a communication interface coupled to each of the at least one processor and the memory,
wherein the at least one processor is configured to:
receive at least one dataset including a first data point representing a first entity;
determine, via a trained model, which data points from the at least one dataset reach a positive outcome and which data points from the at least one dataset reach a negative outcome based on a predetermined distance threshold;
determine transition labels from historical data;
calculate an optimal distance function and an optimal threshold value for the at least one dataset based on the transition labels;
generate an augmentation algorithm based on the optimal distance function and the optimal threshold value; and
when the first data point is determined to reach the negative outcome, generate a first recourse path for the first entity to reach the positive outcome by applying the augmentation algorithm to insert a second data point into the at least one dataset,
wherein the second data point is usable to create a transition that enables the first recourse path to extend from the first data point toward the positive outcome.

11. The computing apparatus according to claim 10, wherein the at least one processor is further to:
format raw data from the at least one dataset into a predetermined format by applying a data distribution sampling strategy,
wherein the augmentation algorithm is further based on the formatted raw data.

12. The computing apparatus according to claim 10, wherein the trained model is trained for predictive recourse path modeling,
wherein the first recourse path includes a first series of data points from the at least one dataset that extend from a negative outcome side of a predetermined decision boundary to a positive outcome side of the predetermined decision boundary, and
wherein a respective distance between each data point from the first series of data points and an adjacent data point from the first series of data points is less than the predetermined threshold distance.

13. The computing apparatus according to claim 10, wherein the transition labels are based on a predetermined feasible transition strategy usable for determining whether moving between a first historical data point to a second historical data point is feasible.

14. The computing apparatus according to claim 10, wherein the at least one processor is further to:
validate the first recourse path by determining that each distance between each point within the first recourse path is less than or equal to the predetermined distance threshold.

15. The computing apparatus according to claim 10, wherein the trained model includes at least one from among a deep learning model, a neural network model, a machine learning model, and a logistic regression model.

16. The computing apparatus according to claim 10, wherein each consecutive data point along the first recourse path progresses closer to the positive outcome.

17. The computing apparatus according to claim 10, wherein the at least one dataset relates to at least one from among healthcare data and financial data, and
wherein the first recourse path includes actionable steps for the first entity to reach the positive outcome.

18. The computing apparatus according to claim 17, wherein the at least one dataset relates to financial data, and
wherein the decision relates to acceptance to at least one from among a service, a credit line, and an opportunity.

19. A non-transitory computer readable storage medium storing instructions for determining a recourse path with respect to a decision that is associated with a positive outcome and a negative outcome, the storage medium comprising executable code which, when executed by at least one processor, causes the at least one processor to:
receive at least one dataset including a first data point representing a first entity;
determine, via a trained model, which data points from the at least one dataset reach a positive outcome and which data points from the at least one dataset reach a negative outcome based on a predetermined distance threshold;
determine transition labels from historical data;
calculate an optimal distance function and an optimal threshold value for the at least one dataset based on the transition labels;
generate an augmentation algorithm based on the optimal distance function and the optimal threshold value; and
when the first data point is determined to reach the negative outcome, generate a first recourse path for the first entity to reach the positive outcome by applying the augmentation algorithm to insert a second data point into the at least one dataset,
wherein the second data point is usable to create a transition that enables the first recourse path to extend from the first data point toward the positive outcome.

20. The storage medium according to claim 19, wherein the trained model is trained for predictive recourse path modeling,
wherein the first recourse path includes a first series of data points from the at least one dataset that extend from a negative outcome side of a predetermined decision boundary to a positive outcome side of the predetermined decision boundary, and
wherein a respective distance between each data point from the first series of data points and an adjacent data point from the first series of data points is less than the predetermined threshold distance.
